(19) United States
(12) Patent Application Publication
(10) Pub. No.: US 2016/0003129 A1
(43) Pub. Date: Jan. 7, 2016

(54) BEARING PLATE BLEED PORT FOR ROOTS-TYPE SUPERCHARGERS

(71) Applicant: EATON CORPORATION, Cleveland, OH (US)

(72) Inventors: Matthew Gareld SWARTZLANDER, Battle Creek, MI (US); Jason Christopher KOVAL, Dimondale, MI (US)

(21) Appl. No.: 14/854,642

(22) Filed: Sep. 15, 2015

Related U.S. Application Data
(63) Continuation of application No. PCT/US2014/025760, filed on Mar. 13, 2014.
(60) Provisional application No. 61/794,817, filed on Mar. 15, 2013.

(51) Int. Cl. F02B 33/38; F04C 28/18; F02B 39/04; F02B 39/16; F04C 18/12; F04C 29/12

(52) U.S. Cl. CPC F02B 33/38; F04C 18/126; F04C 29/12; F02B 39/04; F02B 39/16; F04C 28/18

(57) ABSTRACT

A Roots-type supercharger 100, 1100 includes a housing 120, 1120, a first rotor 200, a second rotor 300, an outlet volume 400, a transfer volume 500, and a bleed port 600, 600′, 1600. The housing includes an interior chamber 130, an inlet port 140, and an outlet port 150, 1150. The first rotor 200 and the second rotor 300 have a plurality of lobes 210, 310, respectively. The outlet volume 400 is substantially bounded between the outlet port, the first rotor, the second rotor, and the interior chamber of the housing. The transfer volume 500 is substantially bounded between the first rotor, the second rotor, and the interior chamber of the housing. The bleed port 600, 600′, 1600 is adapted to fluidly connect the outlet volume and the transfer volume at least during a portion of a transfer volume cycle. The variable bleed port may include a plate that pivots about a pivot or slides along a slide. The plate may be arc shaped and may arc around a centerline of one of the rotors. The plate may be positioned within an operating cavity. The operating cavity may be defined within the housing between a bearing plate and a main housing of the housing. A method of supercharging an internal combustion engine includes bleeding a transfer volume to an outlet volume through a bleed port.

### CROSS-REFERENCE TO RELATED APPLICATION

This application is a Continuation of PCT/US2014/025760, filed 13 Mar. 2014, which claims benefit of U.S. Provisional Application Serial No. 61/794,817, filed 15 Mar. 2013 and which applications are incorporated herein by reference. To the extent appropriate, a claim of priority is made to each of the above disclosed applications.

### TECHNICAL FIELD

The present disclosure relates to Roots-type superchargers. More particularly, the present disclosure is directed to noise reduction and active tuning of Roots-type superchargers.

### BACKGROUND

Superchargers may boost performance of internal combustion engines. For middle to high speed conditions with no or low boost, a Roots-type supercharger may develop a high pressure area opposite the inlet within each rotor transfer volume. This high pressure zone can create undesired levels of noise in the outlet when the transfer volume is opened to the outlet. Such noise is typically an undesired effect produced by Roots-type superchargers under these conditions.

### SUMMARY

According to certain aspects of the present disclosure, a Roots-type supercharger includes a housing, a first rotor, a second rotor, an outlet volume, a transfer volume, and a bleed port. The housing includes an interior chamber, an inlet port, and an outlet port. The first and the second rotor each have a plurality of lobes. The outlet volume is substantially bounded between the outlet port, the first rotor, the second rotor, and the interior chamber of the housing. The transfer volume is substantially bounded between the first rotor, the second rotor, and the interior chamber of the housing. The bleed port is adapted to fluidly connect the outlet volume and the transfer volume at least during a portion of a transfer volume cycle.

According to other aspects of the present disclosure, a method of supercharging an internal combustion engine includes providing a Roots-type supercharger and bleeding a transfer volume to an outlet volume through a bleed port. The Roots-type supercharger includes a first rotor, a second rotor, a housing, an outlet port, and a bleed port. The outlet volume is substantially bounded between the outlet port, the first rotor, the second rotor, and an interior chamber of the housing. The transfer volume is substantially bounded between the first rotor, the second rotor, and the interior chamber of the housing.

In certain embodiments, the bleed port is a variable bleed port. In other embodiments, the bleed port may be a fixed bleed port. The variable bleed port may be controlled by an actuator. The actuator may include a motor. The actuator may be controlled by a controller. The variable bleed port may include an annular portion with a centerline offset from a centerline of a corresponding rotor of the first rotor and the second rotor. The variable bleed port may include an annular portion with a centerline co-linear with a centerline of a corresponding rotor of the first rotor and the second rotor.

In certain embodiments, the variable bleed port includes a plate that pivots. In certain embodiments, the plate includes an arc shape. The arc shape may arc around the centerline of the rotor. The plate may be positioned within an operating cavity. The operating cavity may be defined within the housing. The operating cavity may be defined between a bearing plate and a main housing of the housing.

A variety of additional aspects will be set forth in the description that follows. These aspects can relate to individual features and to combinations of features. It is to be understood that both the foregoing general description and the following detailed description are exemplary and explanatory only and are not restrictive of the broad concepts upon which the embodiments disclosed herein are based.

### BRIEF DESCRIPTION OF THE DRAWINGS

FIG. 1 is a perspective view of a Roots-type supercharger according to the principles of the present disclosure;

FIG. 2 is the perspective view of FIG. 1, but is exploded;

FIG. 3 is the perspective view of FIG. 1, but cutaway through and to a plane including centerlines of a pair of rotors;

FIG. 4 is an enlarged portion of FIG. 3;

FIG. 5 is the exploded perspective view of FIG. 2, but cutaway to and through the plane including the centerlines of the pair of rotors;

FIG. 6 is another perspective view of the Roots-type supercharger of FIG. 1 illustrating an inlet and an outlet of the Roots-type supercharger;

FIG. 7 is the perspective view of FIG. 6, but cutaway to and through a plane perpendicular to the rotor centerlines and through a variable outlet port of the Roots-type supercharger, the variable outlet port shown in a no-bleed configuration;

FIG. 8 is a partial perspective view of the Roots-type supercharger of FIG. 1 illustrating a pair of drive gears and the outlet;

FIG. 9 is still another perspective view with the orientation and scale of FIG. 8, but cutaway to and through the cutaway plane of FIG. 7, the variable outlet port shown in the no-bleed configuration of FIG. 7;

FIG. 10 is the cutaway perspective view of FIG. 7, but with a variable bleed port of the variable outlet port in a mostly open configuration;

FIG. 11 is the cutaway perspective view of FIG. 9, but with the variable bleed port in the mostly open configuration of FIG. 10;

FIG. 12 is a partial elevation side view of the Roots-type supercharger of FIG. 1;

FIG. 13 is an end cross-sectional view of the Roots-type supercharger of FIG. 1, as called out at FIG. 12, with the variable bleed port shown in the no-bleed configuration of FIG. 7;

FIG. 14 is the end cross-sectional view of FIG. 13, but with the variable bleed port shown in the mostly open configuration of FIG. 10;

FIG. 15 is a perspective view of a pair of rotors and a bearing plate of a Roots-type supercharger according to the principles of the present disclosure, the Roots-type supercharger including a pair of fixed bleed ports;

FIG. 16 is the perspective view of FIG. 15, but is exploded;

FIG. 17 is a perspective view of another Roots-type supercharger according to the principles of the present disclosure;

FIG. 18 is the perspective view of FIG. 17, but cutaway to and through a plane perpendicular to rotor centerlines and through a variable outlet port of the Roots-type supercharger, the variable outlet port shown in a no-bleed configuration;

FIG. 19 is the cutaway perspective view of FIG. 18, but with a pair of variable bleed ports of the variable outlet port in an open configuration;

FIG. 20 is a perspective view of a pair of rotors and a bearing plate of the Roots-type supercharger of FIG. 17, the bearing plate including the pair of variable bleed ports of FIG. 19 in the no-bleed configuration of FIG. 18;

FIG. 21 is the perspective view of FIG. 20, but with the pair of variable bleed ports in the open configuration of FIG. 19; and

FIG. 22 is an end view of the pair of rotors and the bearing plate of FIG. 20 with the pair of variable bleed ports in the open configuration of FIG. 19.

### DETAILED DESCRIPTION

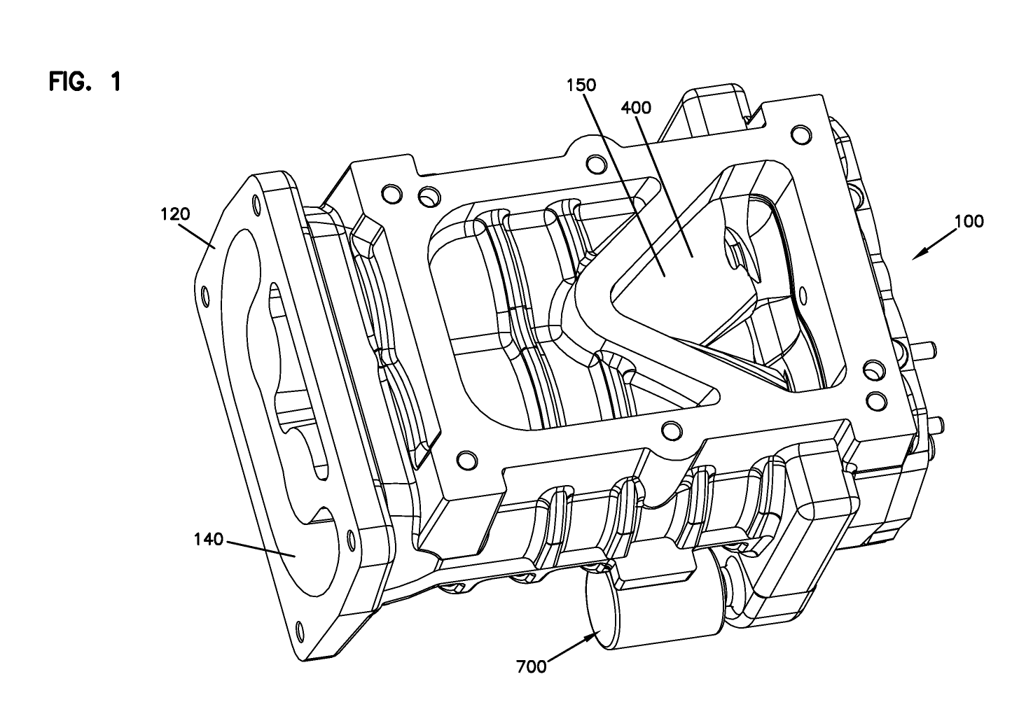

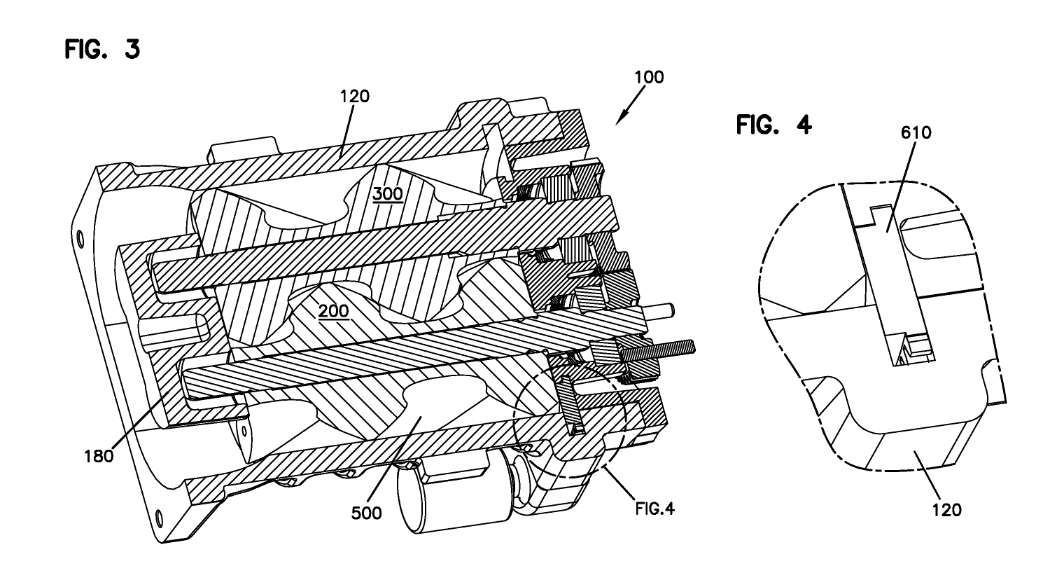

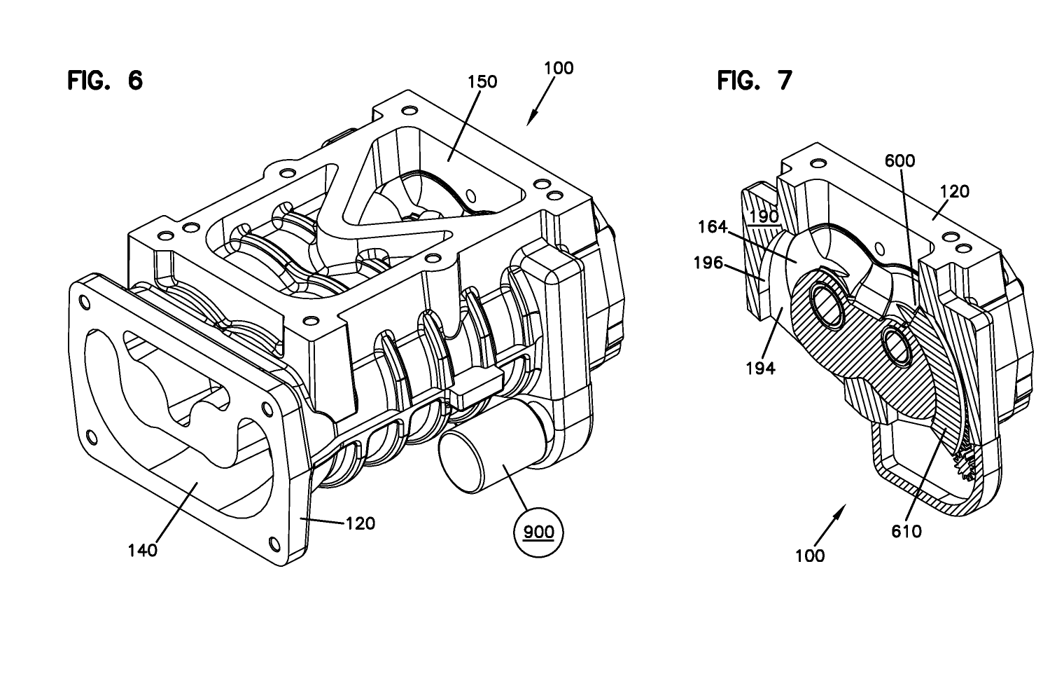

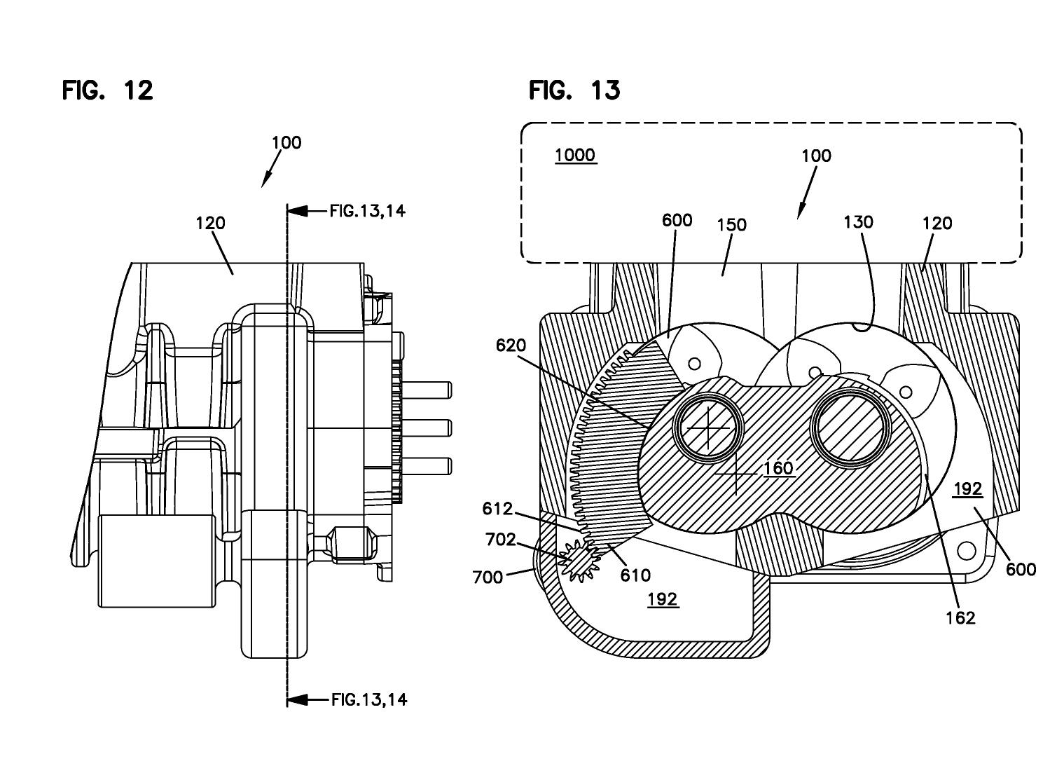

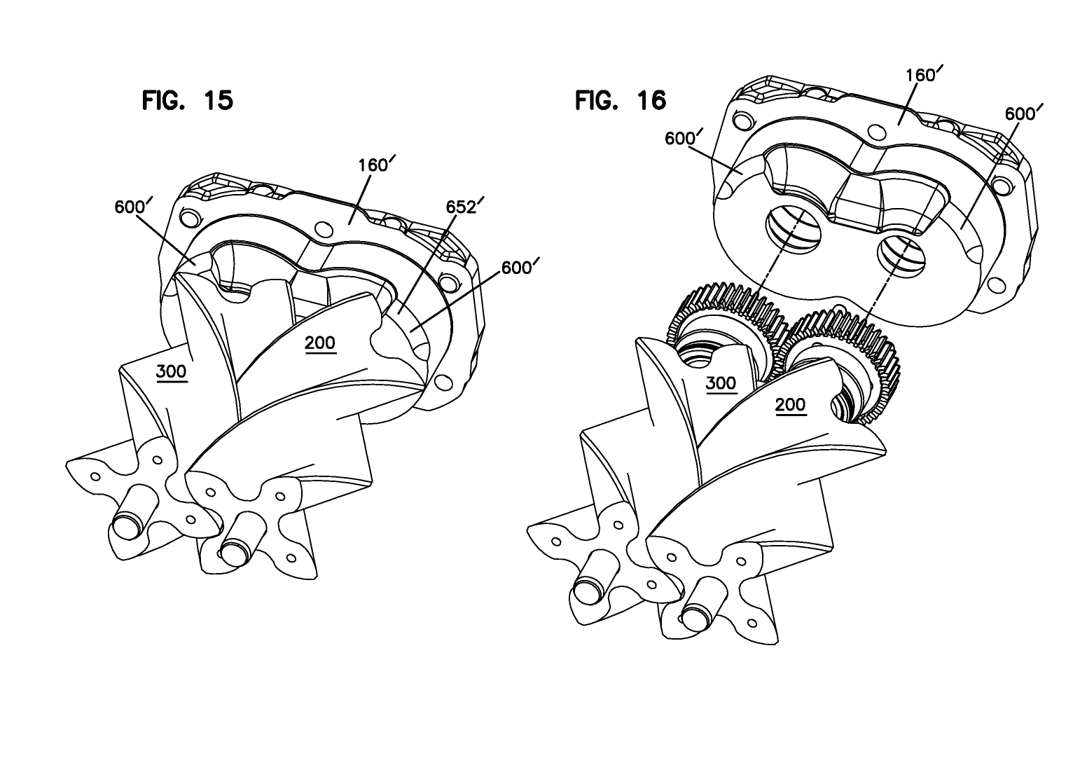

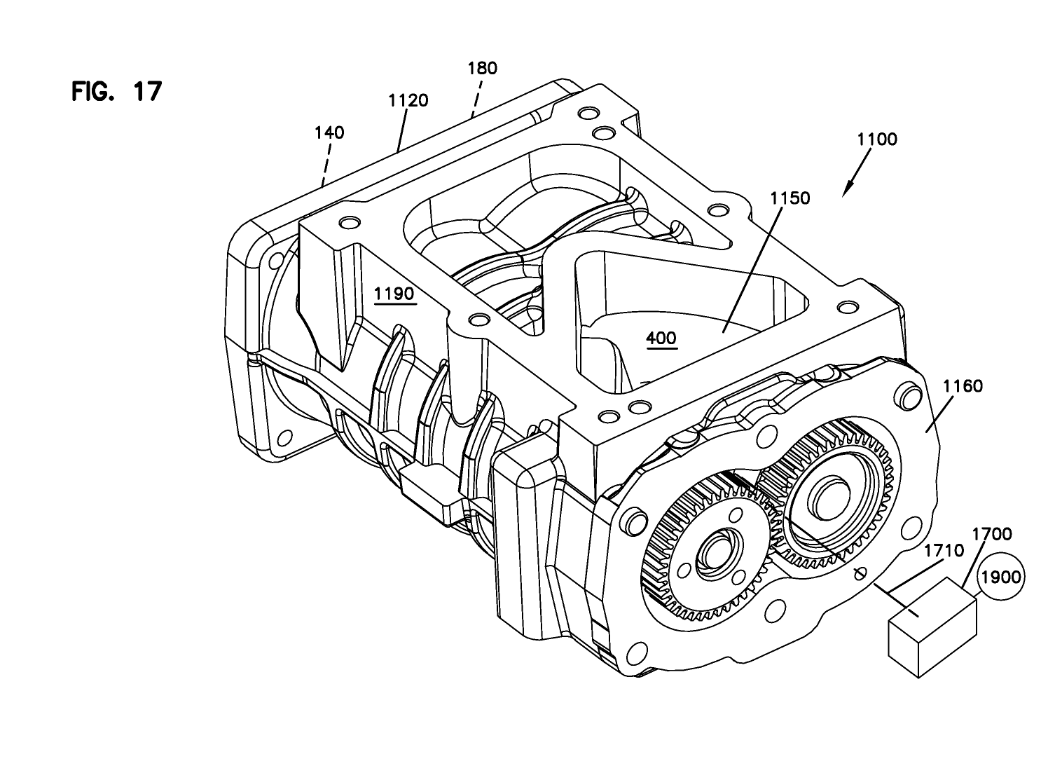

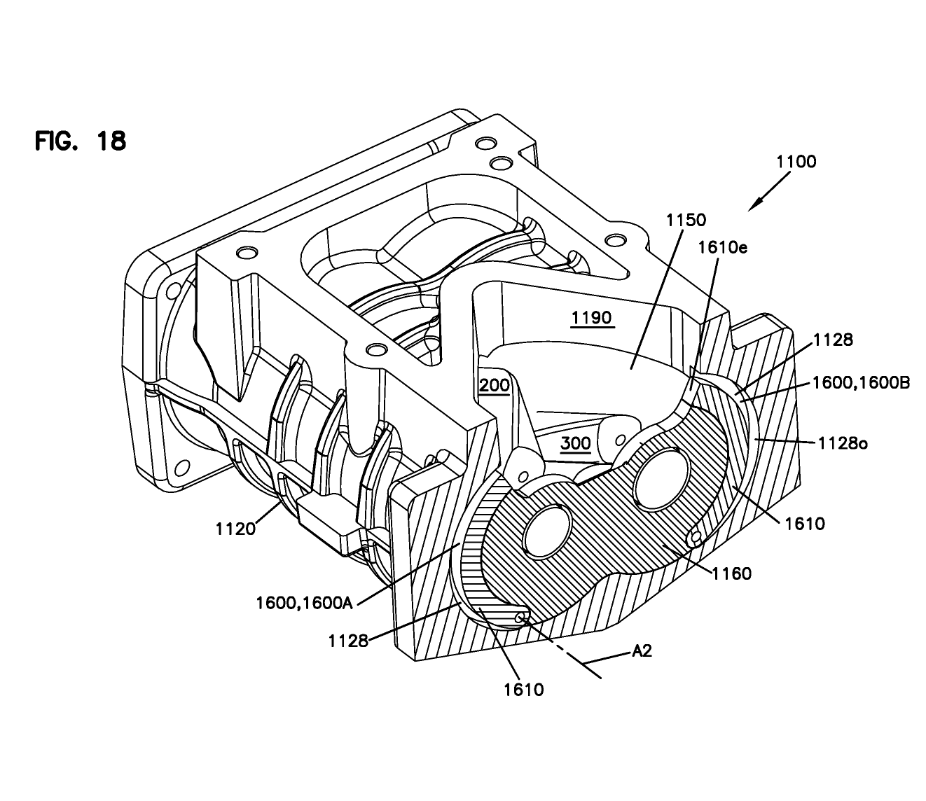

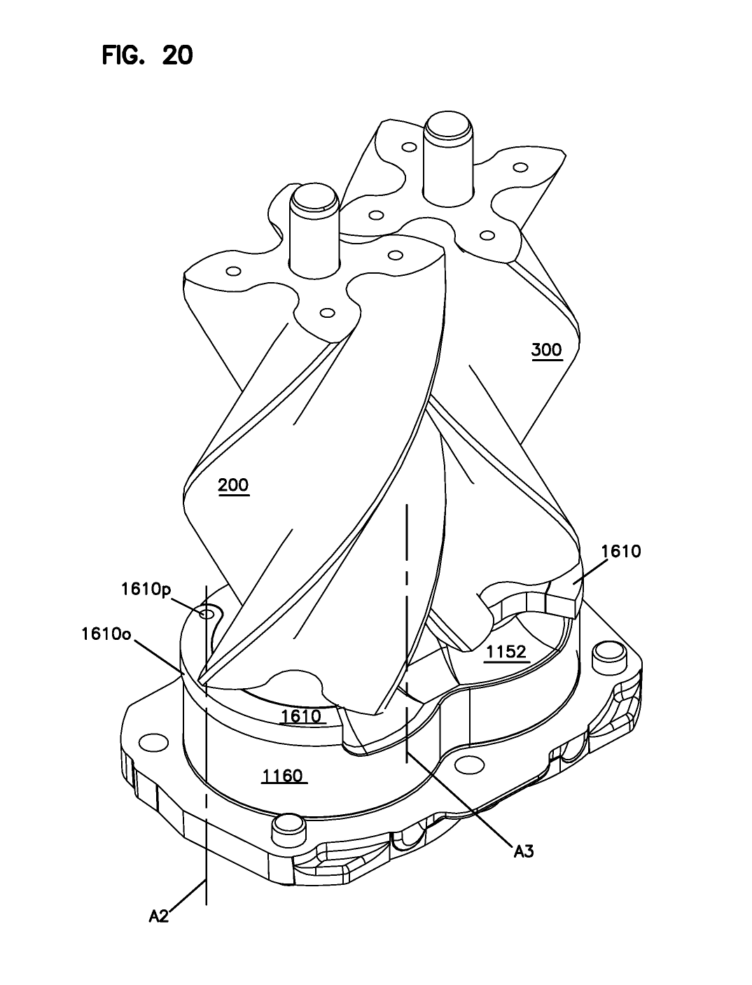

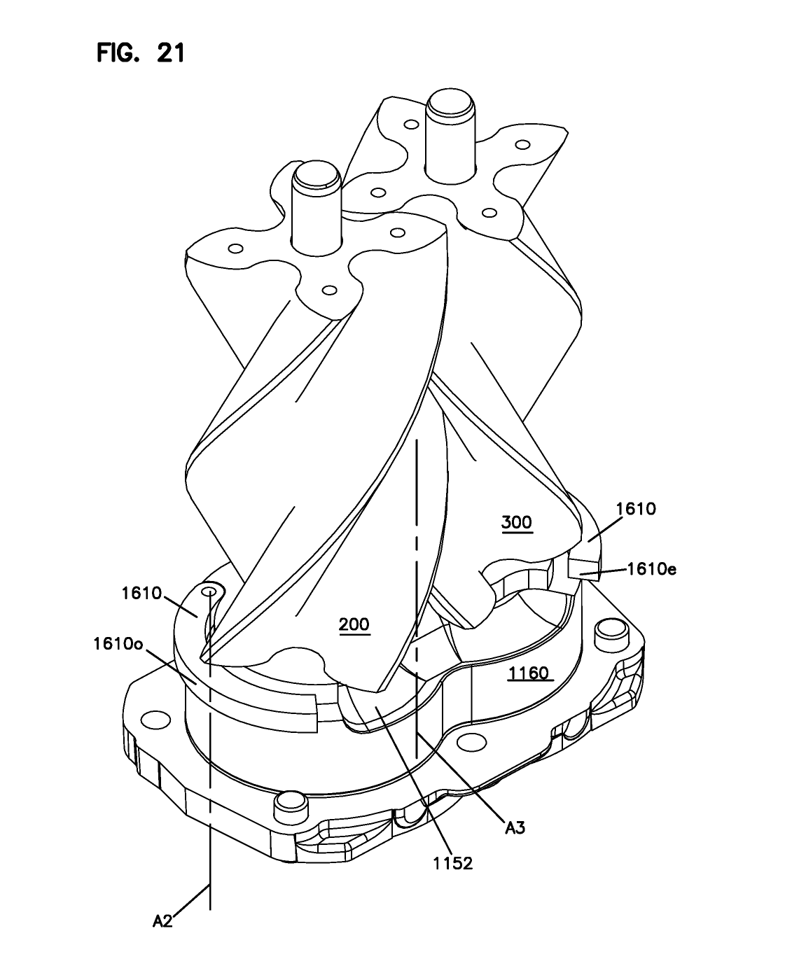

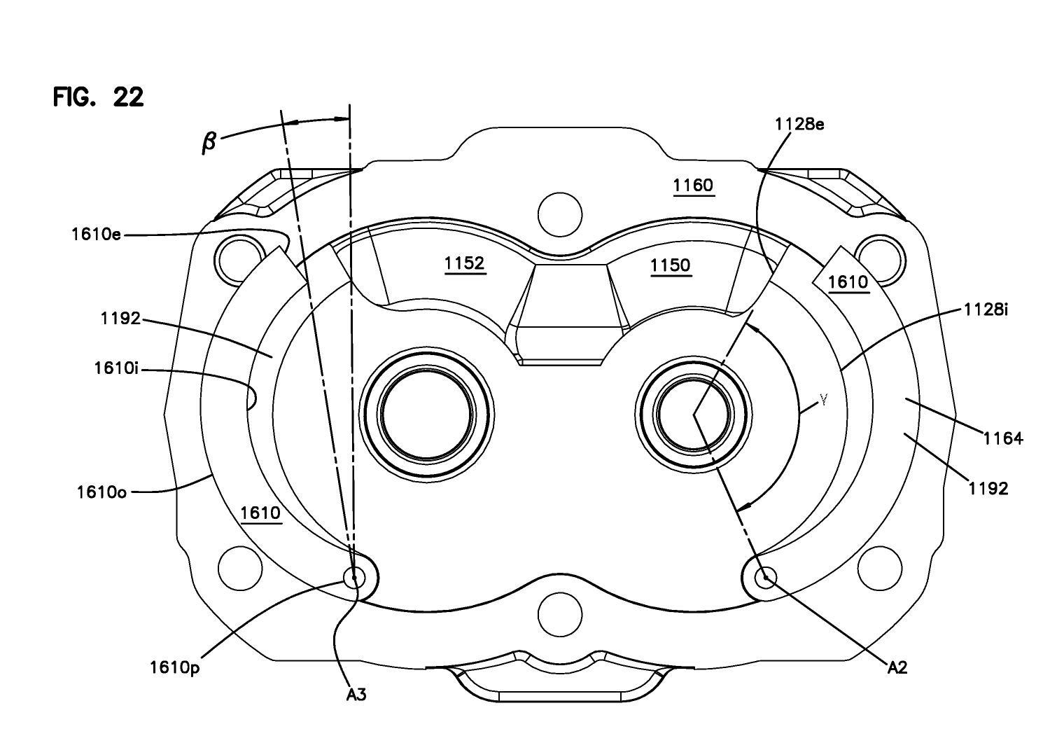

According to the principles of the present disclosure, a Roots-type supercharger includes at least one bleed port that may be used to reduce noise generated by the Roots-type supercharger. Three example embodiments are illustrated in the drawings. A Roots-type supercharger 100 that includes at least one bleed port 600 that may be used to reduce noise generated by the Roots-type supercharger 100 is illustrated at FIGS. 1-14. A bearing plate 160′ of a Roots-type supercharger similar to the Roots-type supercharger 100 includes at least one bleed port 600′ that may be used to reduce noise generated by the Roots-type supercharger and is illustrated at FIGS. 15 and 16. And, a Roots-type supercharger 1100 that includes at least one bleed port 1600 that may be used to reduce noise generated by the Roots-type supercharger 1100 is illustrated at FIGS. 17-22. In particular, the embodiments depicted in the figures include a pair of bleed ports 600, 600′, 1600. As depicted, the Roots-type supercharger 100, 1100 includes an outlet port 150, 1150 with at least a portion 152, 1152 of the outlet port 150, 1150 included on a first bearing plate 160, 160′, 1160. As depicted, the first bearing plate 160, 160′, 1160 further includes at least a portion 652, 652′, 1652 of the bleed port 600, 600′, 1600. As depicted, the first bearing plate 160, 160′, 1160 is removable from a main housing 190, 1190. The bleed port 600, 600′, 1600 is defined between the first bearing plate 160, 160′, 1160 and the main housing 190, 1190. The first bearing plate 160, 160′, 1160 and the main housing 190. 1190, assembled together, may form at least a part of a housing assembly 120, 1120.

The housing assembly 120, 1120 includes an interior chamber 130. The housing assembly 120, 1120 further defines an inlet port 140. As depicted, the inlet port 140 is defined on a second bearing plate 180. As depicted, the second bearing plate 180 is integrated (i.e., one piece with) the main housing 190, 1190. The first bearing plate 160, 160′, 1160 and the second bearing plate 180 rotatably support a first rotor 200 and a second rotor 300. Each of the rotors 200, 300 include a plurality of lobes 210, 310. The plurality of lobes 210 of the first rotor 200 generally rotate within a first portion 132 of the interior chamber 130, and the plurality of lobes 310 of the second rotor 300 generally rotate within a second portion 133 of the interior chamber 130. Tips 220 of the plurality of lobes 210 generally run with close clearances to the first portion 132 of the interior chamber 130. Likewise, tips 320 of the plurality of lobes 310 of the second rotor 300 generally run with close clearances to the second portion 133 of the interior chamber 130. The close clearances substantially seal a leading portion of the plurality of lobes 210, 310 from a trailing portion of the same lobe.

The plurality of lobes 210 also mesh with the plurality of lobes 310 during a portion of their rotation. The first plurality of lobes 210 and the second plurality of lobes 310 generally seal with each other when they mesh. The plurality of lobes 210 and 310 also generally seal with the first bearing plate 160, 160′, 1160. In particular, a first end 202 of the first rotor 200 and a first end 302 of the second rotor 300 generally seal with the first bearing plate 160, 160′, 1160. Likewise, a second end 204 of the first rotor 200 generally seals with the second bearing plate 180, and a second end 304 of the second rotor 300 also generally seals with the second bearing plate 180.

An outlet volume 400 (see FIGS. 1 and 17) is substantially bounded between the outlet port 150, 1150, the first rotor 200, the second rotor 300, and the interior chamber 130 of the housing 120, 1120. The interior chamber 130 includes portions of the first bearing plate 160, 160′, 1160 and the second bearing plate 180. The outlet volume 400 is generally at a higher pressure when the Roots-type supercharger 100, 1100 is running The higher pressure may develop a slight leakage across the various seals/close clearances that bound the outlet volume 400. As used herein, the term “substantially bounded” includes these sealing/close clearance boundaries, even though slight leakages may occur across the sealed/close clearance boundaries.

A transfer volume 500 is bounded by the first rotor 200, the second rotor 300, and the interior chamber 130 of the housing 120, 1120. The transfer volume 500 is generally formed once the inlet port 140 is closed off by movement of the plurality of lobes 210, 310. While the transfer volume 500 (i.e., a control volume) is formed from the rotor mesh of the first rotor 200 and the second rotor 300, the incoming fluid generates an axial velocity in the direction of the axis of the rotors, 200, 300. With the transfer volume 500 closed at the inlet port 140, the fluid opposite the inlet port 140 collides with the outlet bearing plate 160, 160′, 1160. The fluid in this area stagnates (i.e., the velocity goes to zero or approaches zero) while new fluid may continue to enter the transfer volume 500. The velocity of the fluid at the outlet bearing plate 160, 160′, 1160 is then converted from dynamic pressure to static pressure. The higher the rotational velocity of the first rotor 200 and the second rotor 300, the higher the static pressure. Additionally, with the transfer volume 500 completely closed off to the inlet port 140 and opened to the outlet port 150, 1150 and as the first rotor 200 and the second rotor 300 rotate, the transfer volume 500 within the interior chamber 130 of the housing 120 is volumetrically reduced as the plurality of lobes 210 intermesh with the plurality of lobes 310. As a displacement of an internal combustion engine 1000 (see FIG. 13) to which the Roots-type supercharger 100, 1100 is connected is typically less than a displacement of the Roots-type supercharger 100, 1100, this reduction in volume increases the pressure of the transfer volume 500 as the volume is reduced. As the first rotor 200 and the second rotor 300 continue to rotate, the transfer volume 500 eventually exits the outlet port 150, 1150. Depending on flow through the outlet port 150, 1150, the pressure generated within the transfer volume 500 (i.e., upon the transfer volume 500 being opened to the outlet port 150, 1150) may vary.

For middle to high speed conditions with no or low boost, the dumping of the transfer volume 500 to the outlet port 150, 1150 may generate high noise levels at the outlet port 150, 1150. According to the principles of the present disclosure, the bleed port 600, 600′, 1600 connects the outlet volume 400 to the transfer volume 500 before the transfer volume 500 is normally open to the outlet port 150, 1150. The bleed port 600, 600′, 1600 thereby alters at least a portion of a transfer volume cycle by an early connection between the transfer volume 500 and the outlet volume 400. As the bleed port 600, 600′, 1600 is of a smaller cross-sectional area when compared to the outlet port 150, the opening of the bleed port 600, 600′, 1600 between the transfer volume 500 and the outlet volume 400 does not necessarily immediately reduce the pressure of the transfer volume 500 to that of the outlet volume 400 (e.g., the pressure at the outlet port 150, 1150).

In certain embodiments, the bleed port 600 is a variable bleed port that can alter the onset of the bleed port 600 opening to the transfer volume 500. In certain embodiments, the bleed port 1600 is a variable bleed port that can alter an effective passage area of the bleed port 1600 opening to the transfer volume 500. In certain embodiments, the bleed port 600, 1600 is a variable bleed port that may vary the cross-sectional area of the bleed port and thereby control an amount of flow that passes through the bleed port 600, at a given pressure.

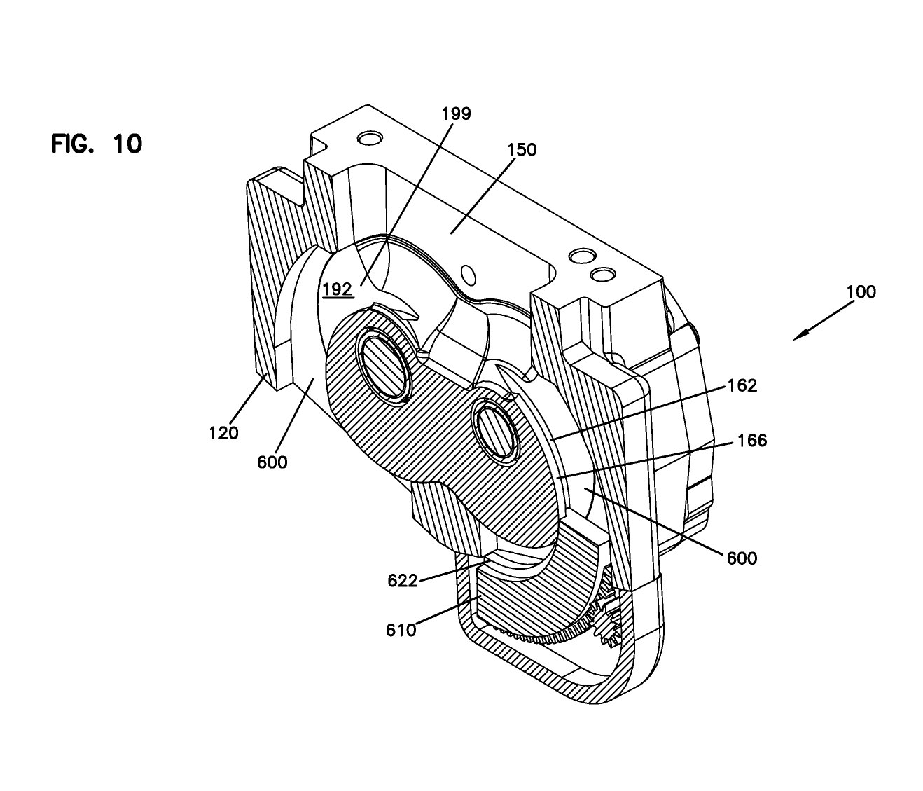

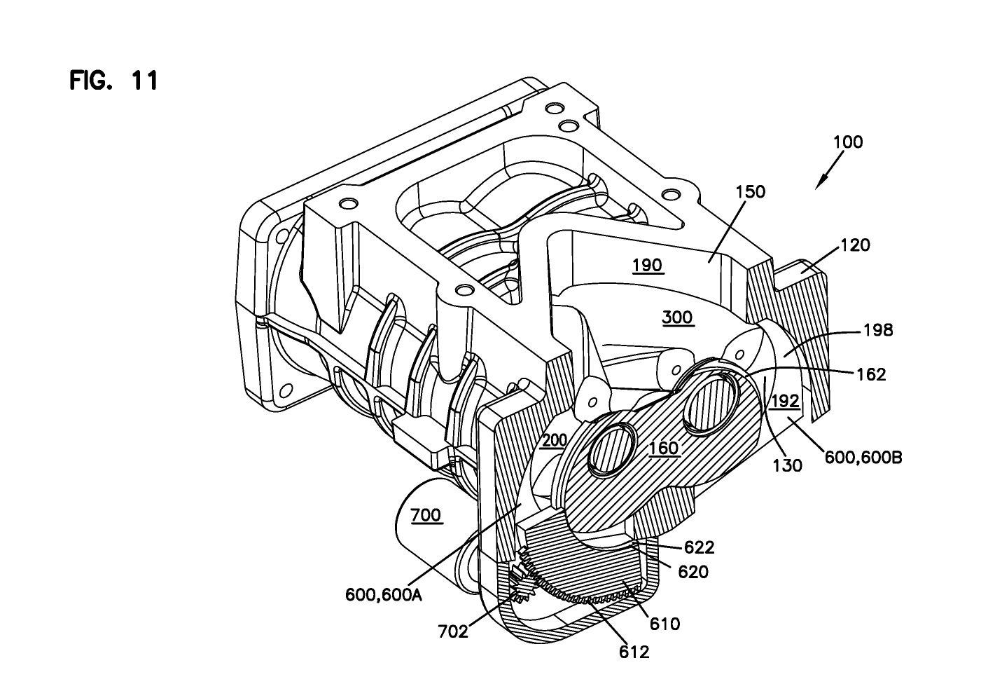

In certain embodiments, the bleed port 600, 1600 is tuned to an operating state of the internal combustion engine 1000 to which the Roots-type supercharger 100, 1100 is connected. At certain conditions, as illustrated at FIGS. 7, 9, 13, 18, and 20 the bleed port 600, 1600 may be substantially closed and thereby substantially not connect the outlet volume 400 to the transfer volume 500. It is appreciated that slight leakages may also occur across the bleed port 600, 1600. Nonetheless, the bleed port 600, 1600 may be substantially closed. In other operating conditions, in particular, at mid to high speeds with no or low boosts, the variable bleed port 600, 1600 may be fully opened, as illustrated at FIGS. 10, 11, 14, 19, 21, and 22. At these conditions, maximum flow, at a given pressure, is available across the bleed port 600, 1600 between the transfer volume 500 and the outlet volume 400.

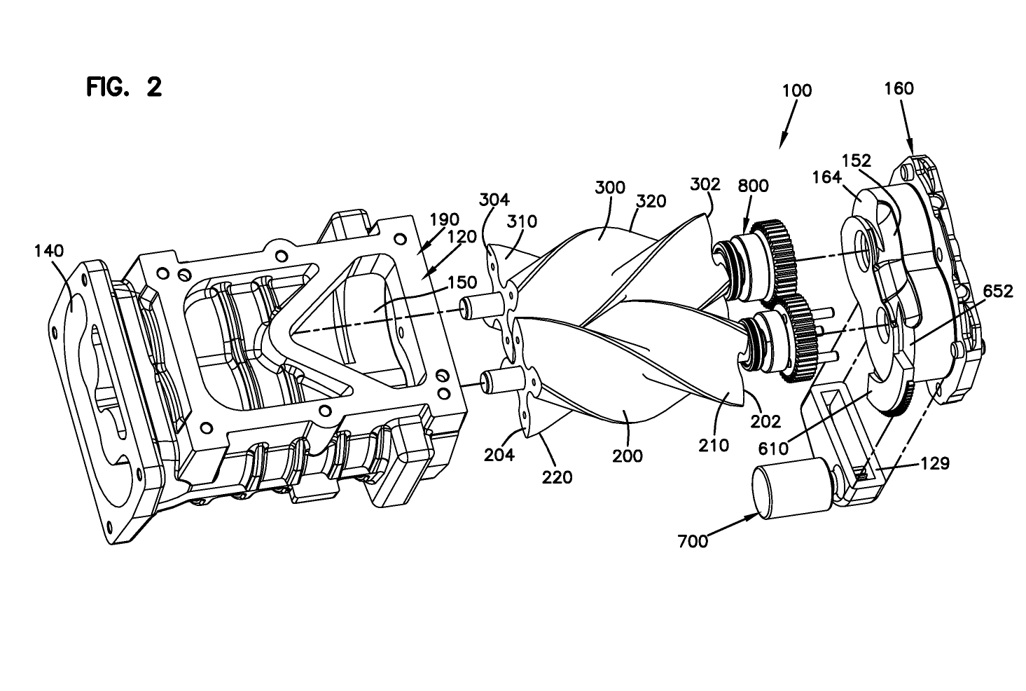

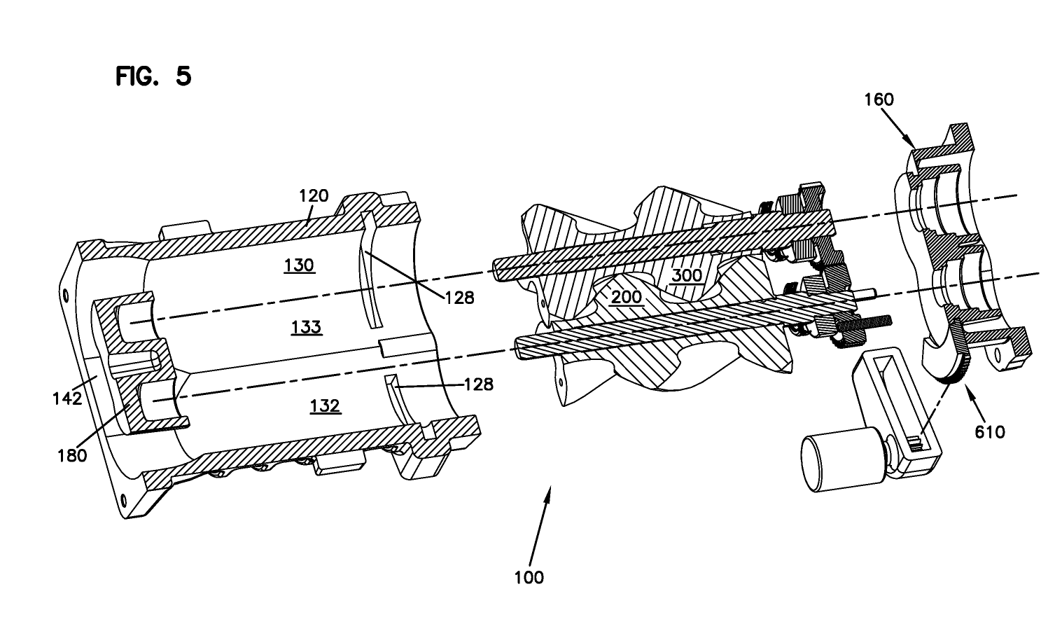

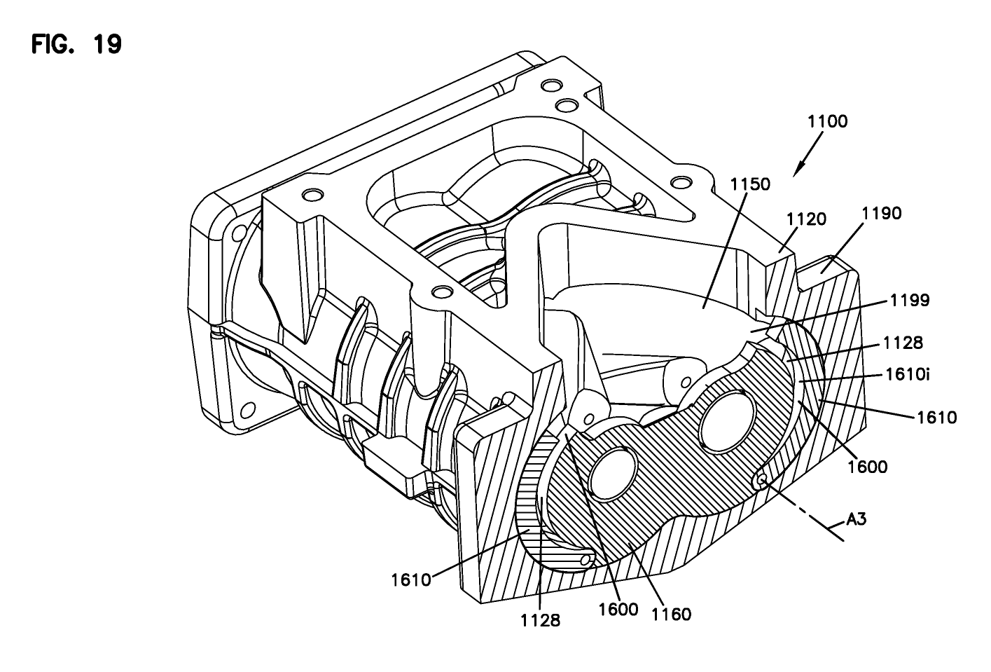

In other operating conditions, the bleed port 600, 1600 may be between the closed position and the fully opened position, as illustrated at FIG. 2. The bleed port 600, 1600 may thereby be tuned to adjust the flow rate and/or the timing at which the onset of the bleed port 600 opening to the transfer volume 500 occurs. An actuator 700, 1700 may be used to drive a position of a port plate 610, 1610 and thereby open and close the bleed port 600, 1600. The actuator 700, 1700 may further tune the opening of the bleed port 600, 1600 between the open and close positions. As illustrated at FIG. 5, openings 128 (e.g., slots) may be included in the housing 120 to facilitate the movement of the port plate 610 as it moves between the open position and the closed position. As illustrated at FIGS. 18 and 19, operating cavities 1128 (e.g., a pair of semi-crescent shaped cavities) may be included in the housing 1120 to facilitate the movement of the port plate 1610 as it moves between the open position and the closed position. A cover 129 may be provided that encloses the port plate 610 and thereby keeps the port plate 610 and a drive of the port plate 610 free from contamination. The cover 129 further prevents excessive pressure leakage across the port plate 610 as the cover 129 can effectively seal with the bleed port 600 and thereby generally maintain a pressure close to or at the pressure of the bleed port 600. The operating cavities 1128 may be blind, at least when the port plate 1610 is at the closed position, and thereby prevent substantial fluid leakage across the port plate 1610.

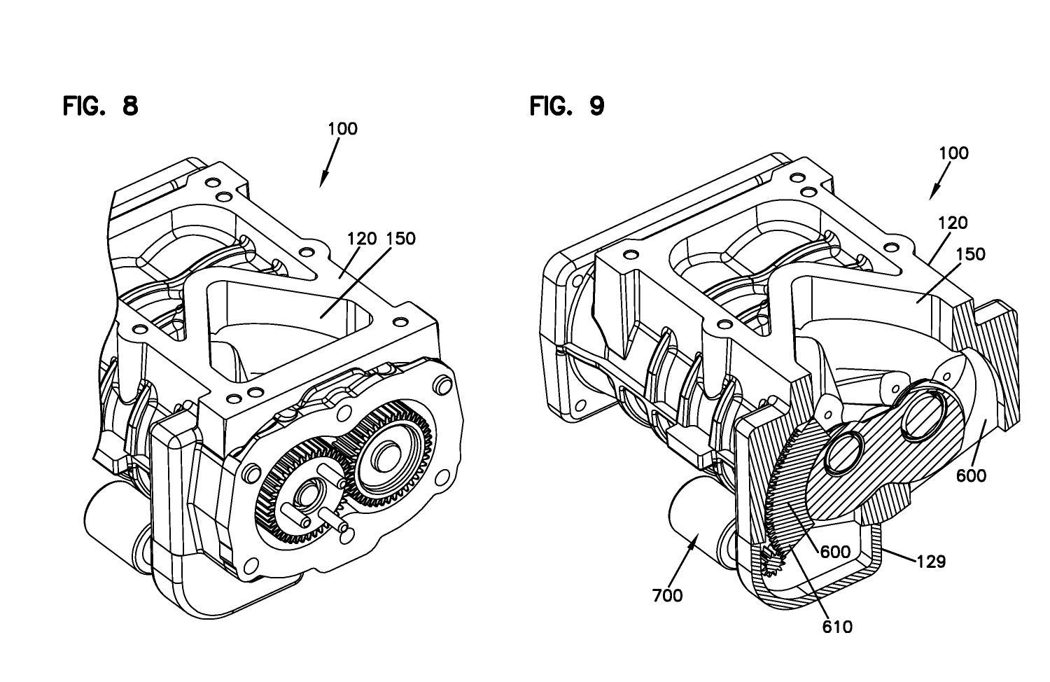

As depicted at FIGS. 9 and 13, the actuator 700 is a motor. In certain embodiments, the motor 700 is a servo motor that is actively responsive to varying conditions of the internal combustion engine 1000. A controller 900 may control the motor 700. By responding to the conditions of the internal combustion engine 1000, the Roots-type supercharger 100, 1100 is continuously tuned with the internal combustion engine 1000.

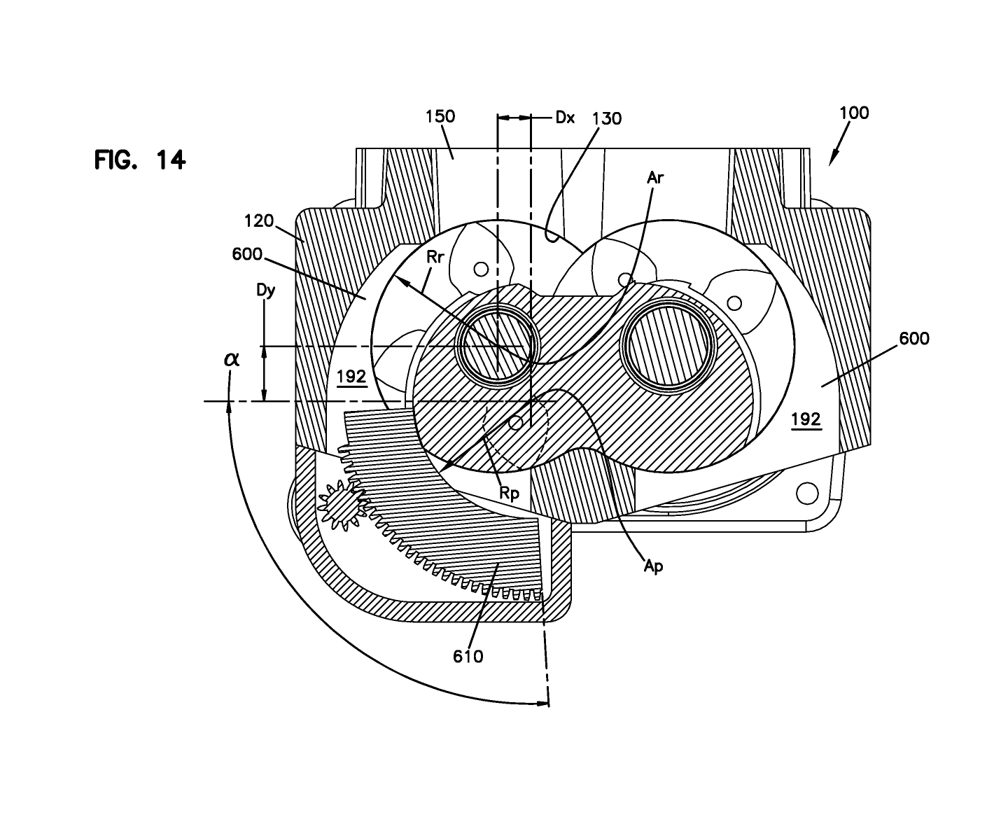

As depicted, the port plate 610 rotates about an axis Ap and is defined in its position by an angular variable α. As illustrated at FIG. 14, the variable α is at a maximum when the bleed port 600 is wide open. As illustrated at FIG. 13, the variable α is at a minimum when the bleed port 600 is fully closed. The axis Ap of the port plate 610 is offset from an axis Ar of a corresponding rotor of either the first rotor 200 or the second rotor 300. By offsetting the axis Ap from the axis Ar, the port plate 610 can swing along a radius Rp and not occupy an annular region that would be left open to the interior chamber 130 when in the fully closed position.

Instead, the radius Rp extends away from the interior chamber 130 at a portion where the port plate 610 is stored when in the open position, as illustrated at FIG. 14. As illustrated, the axis Ap is offset from the axis Ar by a distance Dx in a first direction and by a distance Dy in a second direction. As also illustrated at FIG. 14, the first rotor 200 and the second rotor 300 generally sweep out a radius Rr. In the depicted embodiment, the radius Rp is smaller than the radius Rr.

As illustrated at FIGS. 15 and 16, a fixed bleed port 600′ may be included on the interior chamber 130. As depicted, the fixed bleed port 600′ is positioned on the first bearing plate 160′. Although not adjustable, the fixed bleed port 600′ requires no maintenance or extra parts and thereby may passively bleed the transfer volume 500 to the outlet volume 400. As depicted at FIGS. 15 and 16, the fixed bleed port 600′ is of a constant annular cross section until reaching an end that may be a negative portion of a sphere. In other embodiments, the fixed bleed port 600′ may include a variable cross sectional area as the fixed bleed port 600′ extends along its path. For example, the fixed bleed port 600′ could include a shape that is swept about the radius Rp that is offset from the radius Rr by a distance Dx and/or a distance Dy. The values of the offsets Dx and Dy, as defined at FIG. 14, may be positive and/or negative. The cross-sectional area of the fixed bleed port 600′ could thereby increase or decrease as the variable bleed port 600′ approaches the outlet port 150. In other embodiments, a radius or other cross-sectional shape of the fixed bleed port 600′ may change and thereby produce a variable cross sectional volume for the fixed bleed port 600′ as the fixed bleed port 600′ sweeps along a path.

In preferred embodiments, the bleed ports 600, 600′, 1600 do not open to the transfer volume 500 when the transfer volume 500 is open to the inlet port 140. In these embodiments, the selection of the geometry of the bleed port 600, 600′, 1600 and the geometry of the storage area occupied by the port plate 610, 1610 when in the fully opened position is constrained.

In certain embodiments, the bleed port 600, 1600 may be reduced at low speed operation and increased in opening for high speed operation. In certain embodiments, the bleed port 600, 1600 may be tuned with respect to boost. In particular, a higher boost pressure would position the bleed port 600, 1600 toward the closed position and a low boost pressure would position the bleed port 600, 1600 toward the open position. In certain embodiments, both the speed and the boost pressure are considered when selecting the opening position of the bleed port 600, 1600. Other variables may also be selected to control the bleed port 600, 1600.

In certain embodiments, a first bleed port 600, 1600 is defined corresponding to the first rotor 200 and a second bleed port 600, 1600 is defined corresponding to the second rotor 300. The first and second bleed ports 600, 1600 may substantially be mirror images of each other. In certain embodiments, the first bleed port 600, 1600 and the second bleed port 600, 1600 may be independently adjusted and/or controlled. Tuning of the bleed ports 600, 1600 may be with respect to minimizing noise output of the supercharger 100, 1100. In certain embodiments, the bleed ports 600, 1600 may be tuned to maximize overall efficiency of the internal combustion engine 1000. In certain embodiments, the bleed port 600, 1600 may be tuned in conjunction with bypass valves between the inlet 140 and the outlet 150, 1150 of the supercharger 100, 1100.

Turning now to FIGS. 9-14, the variable bleed ports 600 will be described in detail. The bleed ports 600 include a first bleed port 600A and a second bleed port 600B. The bleed ports 600A and 600B and their respective components may be mirror images of each other. As depicted at FIG. 11, the bleed port 600A corresponds to the first rotor 200, and the bleed port 600B corresponds to the second rotor 300. As depicted, the actuator 700 includes a gear 702. The gear 702 is adapted to mesh with a gear segment 612 of the port plate 610. By turning the gear 702, the actuator 700 can position the port plate 610 by changing the angle a. The port plate 610 is guided by a guide 620. The guide 620 may include a guide way 162 on the bearing plate 160 and a corresponding guide way 622 on the port plate 610. Movement of the port plate 610 is thereby guided to rotate about the axis Ap by the guide 620.

The port plate 610 operates within, substantially within, or partially within an operating cavity 192. As depicted, the operating cavity 192 is at least partially defined by the main housing 190. The operating cavity 192 may be bounded by a face 164 of the bearing plate 160 (see FIG. 2) and a face 194 of the main housing 190 (see FIG. 7). The operating cavity 192 may be further bounded by a face 196 (e.g., a cylindrical face) of the main housing 190 and a face 166 (e.g., a cylindrical face) of the bearing plate 160 (see FIGS. 7 and 10). The face 166 or faces 166 may also define at least a portion of the guide way 162. The operating cavity 192 may be further bounded by a face 198 of the main housing 190 (see FIG. 11). The operating cavity 192 may be variably opened to the transfer volume 500 by movement of the port plate 610. The operating cavity 192 includes an opening 199 to the outlet port 150 (see FIG. 10).

Turning now to FIGS. 18-22, the variable bleed ports 1600 will be described in detail. The bleed ports 1600 include a first bleed port 1600A and a second bleed port 1600B. The bleed ports 1600A and 1600B and their respective components may be mirror images of each other. As depicted at FIG. 18, the bleed port 1600A corresponds to the first rotor 200, and the bleed port 1600B corresponds to the second rotor 300. As depicted at FIG. 17, the actuator 1700 includes a shaft 1710. The shaft 1710 is adapted to rotate a pivot 1610p of the port plate 1610 (see FIG. 22). By rotating the pivot 1610p, the actuator 1700 can position the port plate 1610 by changing the angle β. The port plate 1610 is guided by the pivot 1610p to rotate about a corresponding axis A2, A3. Movement of the port plate 1610 is thereby guided to rotate about the axis A2 or A3, respectively.

The port plate 1610 operates within, substantially within, or partially within an operating cavity 1128 (see FIG. 18). The operating cavity 1128 includes a passage 1128e to the outlet port 1150. The port plate 1610 may be guided by the operating cavity 1128 (e.g., by surface contact). As depicted, the operating cavity 1128 is at least partially defined by the main housing 1190. The operating cavity 1128 may be bounded by a face 1164 of the bearing plate 1160 (see FIG. 22) and a face of the main housing 1190 similar to the face 194 (see FIG. 7). The operating cavity 1128 may be further bounded by a face 1128o (e.g., a cylindrical face) of the main housing 1190 (see FIG. 18) and a face 1128i (e.g., a cylindrical face) of the bearing plate 1160 (see FIG. 22). The operating cavity 1128 may be variably opened to the transfer volume 500 by movement of the port plate 1610. The operating cavity 1128 includes an opening 1199 to the outlet port 1150 (see FIG. 19).

The port plate 1610 includes a first surface 1610i that interfaces with the face 1128i and defines a portion of the bleed port 1600. The port plate 1610 includes a second surface 1610o that interfaces with the face 1128o. The port plate 1610 includes a third surface 1610e that defines an end of the port plate 1610. The third surface 1610e may define a portion of the outlet port 1150 (e.g., when the bleed port 1600 is closed, as illustrated at FIG. 18). As depicted, the port plate 1610 includes the pivot 1610p. As depicted, the pivot is opposite the third surface 1610e. As depicted, the port plate 1610 and the operating cavity 1128 define an arc that sweeps about an angle γ (see FIG. 22). The angle y may be selected such that the bleed port 1600 connects the outlet volume 400 to the transfer volume 500 at a desired time of the cycle. The selection of the angle γ may depend on the number n of the lobes 210, 310 on the rotors 200, 300. As depicted, the axis A2, A3 are fixed relative to the housing 1120. In other embodiments, the axis A2, A3 may move to further tune the Roots-type supercharger 1100.

Various modifications and alterations of this disclosure will become apparent to those skilled in the art without departing from the scope and spirit of this disclosure, and it should be understood that the scope of this disclosure is not to be unduly limited to the illustrative embodiments set forth herein.

What is claimed is:

1. A Roots-type supercharger 100 comprising:
a housing 120 including an interior chamber 130, an inlet port 140, and an outlet port 150;
a first rotor 200 with a plurality of lobes 210;
a second rotor 300 with a plurality of lobes 310;
an outlet volume 400 substantially bounded between the outlet port, the first rotor, the second rotor, and the interior chamber of the housing;
a transfer volume 500 substantially bounded between the first rotor, the second rotor, and the interior chamber of the housing; and
a bleed port 600, 600′ adapted to fluidly connect the outlet volume and the transfer volume at least during a portion of a transfer volume cycle.

2. The Roots-type supercharger of claim 1, wherein the housing includes a first bearing plate 160 and the first bearing plate defines at least a portion 152 of the outlet port.

3. The Roots-type supercharger of claim 2, wherein the first bearing plate defines at least a portion 652 of the bleed port.

4. The Roots-type supercharger of claim 2, wherein the housing includes a second bearing plate 180 and the second bearing plate defines at least a portion 142 of the inlet port.

5. The Roots-type supercharger of claim 2, wherein the first bearing plate is removable from a main housing 190 of the housing.

6. The Roots-type supercharger of claim 4, wherein the second bearing plate is integral with a main housing 190 of the housing.

7. The Roots-type supercharger of claim 2, further comprising a gear set 800 adapted to drive the first rotor and the second rotor, wherein the first bearing plate houses at least a portion of the gear set.

8. The Roots-type supercharger of claim 1, further comprising an actuator 700, wherein the bleed port is a variable bleed port 600 controlled by the actuator.

9. The Roots-type supercharger of claim 8, wherein the actuator includes a motor 700.

10. The Roots-type supercharger of claim 8, wherein the variable bleed port includes an annular portion with a centerline offset from a centerline of a corresponding rotor of the first rotor and the second rotor.

11. The Roots-type supercharger of claim 10, wherein setting an angle a of a port plate 610 varies the variable bleed port.

12. The Roots-type supercharger of claim 8, further comprising a controller adapted to continuously control the variable bleed port in response to an operating state of an engine 1000.

13. The Roots-type supercharger of claim 1, wherein the bleed port is a fixed bleed port 600′.

14. The Roots-type supercharger of claim 2, wherein the bleed port is a fixed bleed port 600′ and wherein the first bearing plate defines at least a portion 652′ of the fixed bleed port.

15. The Roots-type supercharger of claim 13, wherein the fixed bleed port includes an annular portion with a centerline offset from a centerline of a corresponding rotor of the first rotor and the second rotor.

16. The Roots-type supercharger of claim 1, wherein the bleed port includes an annular portion with a centerline co-linear with a centerline of a corresponding rotor of the first rotor and the second rotor.

17. A method of supercharging an internal combustion engine, the method comprising:
providing a Roots-type supercharger including a first rotor, a second rotor, a housing, an outlet port, and a bleed port, wherein an outlet volume is substantially bounded between the outlet port, the first rotor, the second rotor, and an interior chamber of the housing and wherein a transfer volume is substantially bounded between the first rotor, the second rotor, and the interior chamber of the housing; and
bleeding the transfer volume to the outlet volume through the bleed port.

18. The method of claim 17, further comprising varying the bleeding of the transfer volume to the outlet volume by varying the bleed port.

19. The method of claim 18, further comprising monitoring a state of the internal combustion engine and coordinating the varying of the bleeding of the transfer volume to the outlet volume with the state of the internal combustion engine.

20. The method of claim 18, further comprising enhancing a performance parameter of the internal combustion engine by the varying of the bleeding of the transfer volume to the outlet volume.

21. The method of claim 18, further comprising reducing noise of the internal combustion engine by the varying of the bleeding of the transfer volume to the outlet volume.
